(19) United States
(12) Patent Application Publication
(10) Pub. No.: US 2001/0040933 A1
(43) Pub. Date: Nov. 15, 2001

(54) Signal filtering

(76) Inventors: Hakan Eriksson, Lund (SE); Joakim Ahlgren, Lund (SE); Michael Breschel, Lund (SE)

Correspondence Address: Stanley R. Moore, Esq., JENKENS & GILCHRIST, P.C., 1445 Ross Avenue, Suite 3200, Dallas, TX, 75202-2799, US

(21) Appl. No.: 09/791,461

(22) Filed: Feb. 22, 2001

(30) Foreign Application Priority Data
Feb. 29, 2000 (GB) 0004872.8

(51) Int. Cl. H04B 1/10

(52) U.S. Cl. 375/350

(57) ABSTRACT

A signal filter comprises a plurality of adding elements (21), each of which has first and second inputs and an output and is operable to provide an output signal representative of the sum of a pair of input signals. The filter also includes a plurality of delay line elements (22), each delay line element having an input and an output and being operable to delay transfer of an input signal from the input to the output by a predetermined time period. The adding elements (21) and delay line elements (22) are connected in a series such that the output of each adding elements, except the last adding element in the series, is connected to the first input of the next adding element in the series via an associated delay line element, the output of the last adding element in the series being connected to the first input of the first adding element in the series via a delay line element. The second input of the adding elements are connected to receive respective input signals.

The present invention relates to signal filtering, and in particular to a filter suitable for use in a CDMA (code division multiple access) radio frequency telecommunication system.

### DESCRIPTION OF THE RELATED ART

Wide band CDMA telecommunications systems, such as described in “Wide Band CDMA For Third Generation Mobile Communications” (Ojanperä and Prasad) Artec House Publishers 1998, use a pilot signal channel to enable synchronisation of the receiver with the incoming transmitted signal. The requirements of a searcher are given in the 3GPP standardization document “Physical channels and mapping of transport channels into physical channels (FDD)”, TS 25.211 and 2.4.0 (1999-09).

However, implementing a pilot signal searcher for WCDMA is expected to be expensive in terms of power consumption and silicon area. It is therefore desirable to optimize the implementation of such a searcher.

A pilot signal searcher is shown in FIG. 1, and consists of four different parts; a matched filter 1 (possibly implemented as a correlator bank or by any other suitable means), a first accumulator 2 for coherent accumulation, a second accumulator 3 for non-coherent accumulation, and a peak detector 4. To enable explanation of the searcher, some terms must be defined:

The spreading factor, denoted α, is the number of chips per symbol. The base station transmits pilots

$${S}_{i , j}^{( l )} = {p}_{j}^{( l )} {a}_{i} {c}_{i , j} \qquad ( 1 )$$

where 1 ε [1, 2] denotes the antenna, i ε [1, . . . , α] is the chip within symbol j. This notation does not take into account the slot structure as defined for the WCDMA system. Furthermore, aᵢ denotes the real valued short code, c_{i,j} the complex valued long code, and pⱼ^{(l)} the pilot symbol. Different physical channels originating from the same base station differ in that different mutual orthogonal short codes, aᵢ, are used. Depending on the type of physical channel and the mode of transmit diversity, the configuration of the pilot symbols pⱼ^{(l)} differs.

Let r(t) denote the complex-valued signal received signal and 1/T_{c} is the chip rate. Then assume that the receiver is synchronized so that all multi-path components are within [0,M−1] chips relative to the known boundary. The output of the matched filter in the path searcher is then given by:

$${x}_{j} ( τ ) = {\sum }_{i = l}^{α} r ( {T}_{c} ( i - τ ) ) {a}_{i} {c}_{i , j}^{*} for all τ ∈ [ 0 , M - 1 ] . \qquad ( 2 )$$

The first accumulator then coherently combines this signal for each pilot symbol as

$${y}_{k} ( τ ) = {\sum }_{j ∈ {Ω}_{k}} {x}_{j} ( τ ) {( {p}_{j}^{( l )} )}^{*} , \qquad ( 3 )$$

where Ωₖ corresponds to a set of adjacent symbols that are coherently accumulated. The output of the second accumulator is then given by:

$$z ( τ ) = {\sum }_{k ∈ Ω} {‖ {y}_{k} ( τ ) ‖}^{2} , \qquad ( 4 )$$

where Ωₖ corresponds to a set of coherently accumulated outputs of the first accumulator. The matched filter of equation (2) could of course be matched to several pilot symbols, with parts of the coherent accumulation is performed by (2).

Basically there are two different types of pilots, common pilots and dedicated pilots. Common pilots are transmitted continuously using common physical channels while the dedicated pilots are time-multiplexed in dedicated physical channels. When the base station uses beam-forming and/or directional antennas to transmit dedicated physical channels it is not possible, in general, to rely on the common pilot for time synchronization of multi-paths. This is due to the fact that common physical channels that originate from an omni-directional antenna could have taken different paths compared to the dedicated physical channels originating from a directional antenna.

The actual pilot pattern depends on the type of pilot channel and which mode of transmit diversity that is used. In 3 GPP, the base station should have the option to use transmit diversity to improve on performance in the down-link. With transmit diversity, each traffic channel is transmitted on two physical channels using two different antennas. These antennas are supposed to be placed close enough for the multi-paths to have approximately the same delays, but separated enough to have uncorrelated fading on each path. To save code space, the two physical channels are transmitted using the same code by using space-time coding of data symbols or by switching between the antennas. This also applies to the pilot symbols which are selected to enable independent channel estimation on the different diversity paths.

If directional antennas are used to transmit dedicated physical channels, then the common physical channels must be transmitted with a separate antenna pair.

The common pilot channel (CPICH) is transmitted continuously using an omni-directional antenna. Let A=1+j. The pilot pattern on CPICH transmitted using antenna one is then

$${p}_{j}^{( 1 )} = A . \qquad ( 5 )$$

Open loop transmit diversity can be used to transmit the CPICH. The CPICH pilot pattern on antenna two is then

$${p}_{j}^{( 2 )} = \{ \begin{matrix}A , for j = 1 , 4 , 5 , 8 , 9 , … \\ - A , for j = 2 , 3 , 6 , 7 , …\end{matrix} \qquad ( 6 )$$

There exists two types of CPICH; the primary CPICH and the secondary CPICH. There differ in that the primary CPICH is always transmitted using the same short code while there may exist multiple secondary CPICHs by allowing them to be multiplexed using different short codes.

Dedicated pilot signals are time multiplexed on dedicated physical channels. The actual configuration depends on the spreading factor and the number of pilot symbols in each slot.

Open loop transmit diversity can be achieved using two different methods; space time block coding based transmit antenna diversity (STTD) and time switched transmit diversity (TSTD). Open loop transmit diversity can be used to transmit all down-link physical channels, but is mainly used for common physical channels, such as PCCPCH, SCH, SCCPCH, PICH and AICH. Also, open loop transmit diversity is used initially before closed loop transmit diversity is established on dedicated physical channels. Furthermore, during soft-handover of dedicated channels, open loop transmit diversity is used. The STTD mode uses mutually orthogonal pilot signals. That is, for each slot, the pilot pattern transmitted on the two antennas are orthogonal. The TSTD mode uses the same pilot pattern on both antennas (not simultaneously). The TSTD mode is only used for the SCH channel, thus the pilot signal searcher need not support the TSTD mode.

Feedback transmit diversity is used to transmit dedicated physical channels. Feedback transmit diversity is defined in two modes; the first mode can be used when the CPICH and dedicated physical channel is transmitted using separate antennas. The second mode assumes that the dedicated physical channel is transmitted using the same pair of antennas as is used to transmit the CPICH.

The two modes differ in how the pilot signals are chosen. The first mode uses mutually orthogonal pilot signals, that is, for each slot, the pilot signals transmitted on the two antennas are orthogonal. The second mode uses the same pilot pattern on both antennas.

For locating services the user equipment could find its position by listening to multiple base stations. This is done by correlating to known pilot signals, as transmitted by each base station. These pilots are transmitted simultaneously within short predetermined time intervals. Thus, the UT must be able to store the received signal corresponding to these intervals and then do the correlation for each base station, using this signal. The result of the correlation is then averaged for a number of consecutive measurements to enhance the signal-to-noise ratio. To facilitate positioning, the implementation must support storing the received signal at quarter chip resolution. Correlation can then be done by the DSP or by using matched filter in the pilot signal searcher.

The present invention is concerned with the design of the matched filter 1. The most straightforward known implementation of the matched filter 1 is to use an FIR (finite impulse response) filter. Such an implementation relies on feeding the input to the filter through a delay line. For long FIR filters this becomes expensive in terms of both power consumption and silicon area. For instance, with a down-link physical channel having a spreading factor of 256, and a pilot signal of four symbols, the complete pilot signal will be 1024 chips long. If the matched filter is intended to provide chip resolution, that is, the sampling rate equals the chip rate, then the straight forward FIR matched filter for this pilot would need to be 1024 long. An alternative known approach is to have an implementation based on a bank of correlators. The problem is then to find a efficient and convenient way to update the coefficients in the correlators.

Referring to FIGS. 1 and 2 of the accompanying drawings, known matched filters will now be described.

Firstly it is necessary to examine the functionality of the matched filter 1. Let xₖ=c_{k-τ}+nₖ denote the input to the matched filter 1 where cₖ is a pilot sequence and nₖ is additive noise. The pilot sequence is known and its length is finite such that cₖ=0 for k<0 and k>L−1. The position of the pilot signal is determined by the delay τ ∈ [0, 1, . . . , M−1]. The output of the pilot matched filter is given by equation (7):

$${y}_{k} = {\sum }_{i} {x}_{k - i} {h}_{i} , \qquad ( 7 )$$

where hᵢ=c_{L-1-i}^{*} and where * denotes complex conjugate.

For estimating the delay τ ∈ [0, 1, . . . , M−1], the peak detector 3 of the searcher must examine the output of the accumulator gₖ in the observation interval:

Ω={k|k ∈[L−1, L, . . . , L−2+M]}. (8)

Thus the only interval of interest is {gₖ|k ∈Ω}.

Since the receiver is synchronized to the base station and we are only interested to search for peaks in a relatively short observation interval Ω, searching over such an interval is appropriate. This means that the corresponding matched filter outputs {yₖ|k ∈Ω} need only be calculated. This observation interval should correspond to the expected maximum delay spread of the channel.

Consider dividing the pilot matched filter in to N sub-filters 10 (10₀. . . 10_{N-1}) and an adder 13 as illustrated in FIG. 2. For simplicity and without loss of generality, let N be a number such that

$$\frac{L}{N}$$

is an integer and define the sub-filter 10₀ to 10_{N-1} coefficients as

$${h}_{k}^{n} = \{ \begin{matrix}{h}_{k + nL / N} , & for all 0 \leq k \leq L / N - 1 \\ 0 & otherwise\end{matrix} for 0 \leq n \leq N - 1. \qquad ( 9 )$$

If xₖ is the input supplied to each sub-filter, see FIG. 2, then the output of each sub-filter is given by equation (10):

$${Y}_{k}^{n} = {\sum }_{i} {x}_{k - 1} {h}_{i}^{n} . \qquad ( 10 )$$

The overall output of the matched filter is then given by equation (11):

$${y}_{k} = {\sum }_{n = 0}^{N - 1} {y}_{k}^{n} {z}^{- nL / N} = {\sum }_{n = 0}^{N - 1} {y}_{k - nL / N}^{n} . \qquad ( 11 )$$

The main problem with the straightforward FIR filter implementation is that the delay line (_{Z}^{-nL/N}) will consume quite a lot of power and silicon area, especially for long pilot signals. Dividing the pilot signal and matched filter into sub-filters does not solve this problem.

If the observation interval is a'priori known, then it is feasible to use a correlation bank to calculate the matched filter output {yₖ|k ∈Ω}. This can be done as envisaged in FIG. 3. The correlator bank comprises a plurality of multipliers 15 each receiving the input signal, xₖ, and respective coefficients c_{R}^{*} to c_{R-M+1}^{*}. The outputs of the multiplexers 15 are supplied to respective adders 16, which provide matched outputs a₀(k) to aₘ₋₁(k). The registers 17 are initialized to zero just before k=0. The output of the matched filter is then given as y_{L-1+p}=aₚ(L−1) for p ∈ {0, 1, . . . , M−1}.

One problem with the correlator bank is how to update the correlation coefficients. A straight forward solution is to feed the correlation coefficients through a delay line (not shown). However, this again is a costly solution in terms of power consumption and silicon area.

It is therefore desirable to provide an improved matched filter which can be of reduced size and complexity for use in any CDMA terminal, or in any synchronization scheme that uses a matched filter.

### SUMMARY OF THE PRESENT INVENTION

According to one aspect of the present invention, there is provided a signal filter comprising:

a plurality of adding elements, each adding element has first and second inputs and an output and being operable to provide an output signal representative of the sum of a pair of input signals; and

a plurality of delay line elements, each delay line element having an input and an output and being operable to delay transfer of an input signal from the input to the output by a predetermined time period,

wherein the adding elements and delay line elements are connected in a series such that the output of each adding elements, except the last adding element in the series, is connected to the first input of the next adding element in the series via an associated delay line element, the output of the last adding element in the series being connected to the first input of the first adding element in the series via a delay line element,

and wherein the second input of the adding elements are connected to receive respective input signals.

### BRIEF DESCRIPTION OF THE DRAWINGS

FIG. 1 is a block diagram illustrating a pilot signal searcher;

FIG. 2 illustrates a matched filter from the searcher of FIG. 1;

FIG. 3 illustrates an alternative matched filter from the searcher of FIG. 1;

FIG. 4 illustrates a first filter embodying the present invention;

FIG. 5 illustrates a second filter embodying the present invention;

FIG. 6 illustrates a third filter embodying a the present invention;

FIG. 7 illustrates a fourth filter embodying the present invention;

FIG. 8 illustrates a fifth filter embodying the present invention; and

FIG. 9 illustrates a sixth filter embodying the present invention.

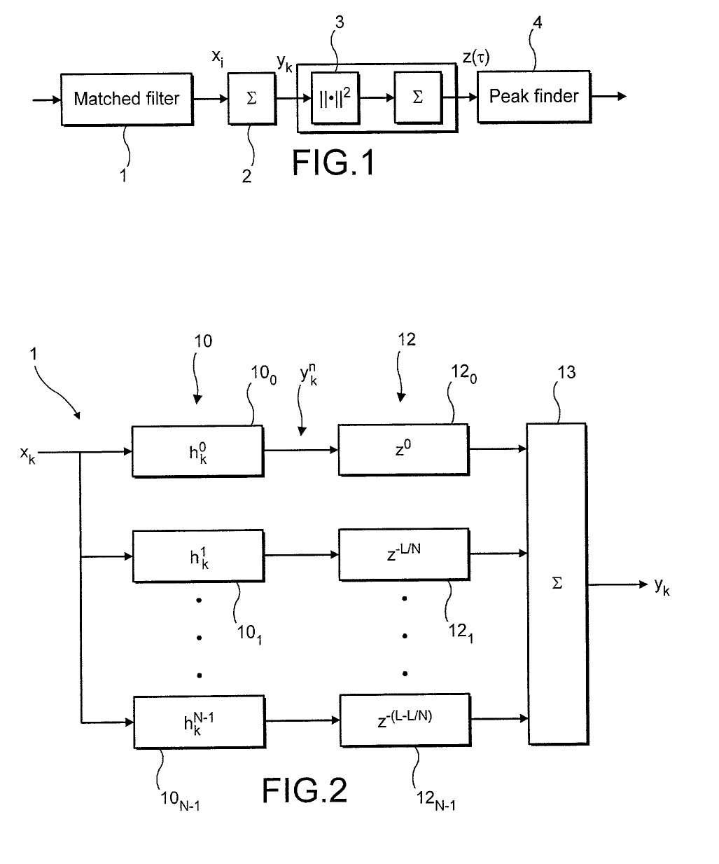

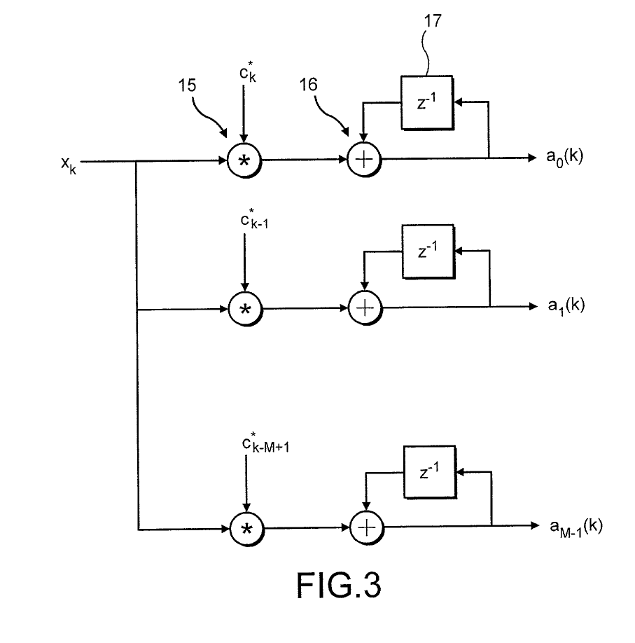

### DESCRIPTION OF THE PREFERRED EMBODIMENTS

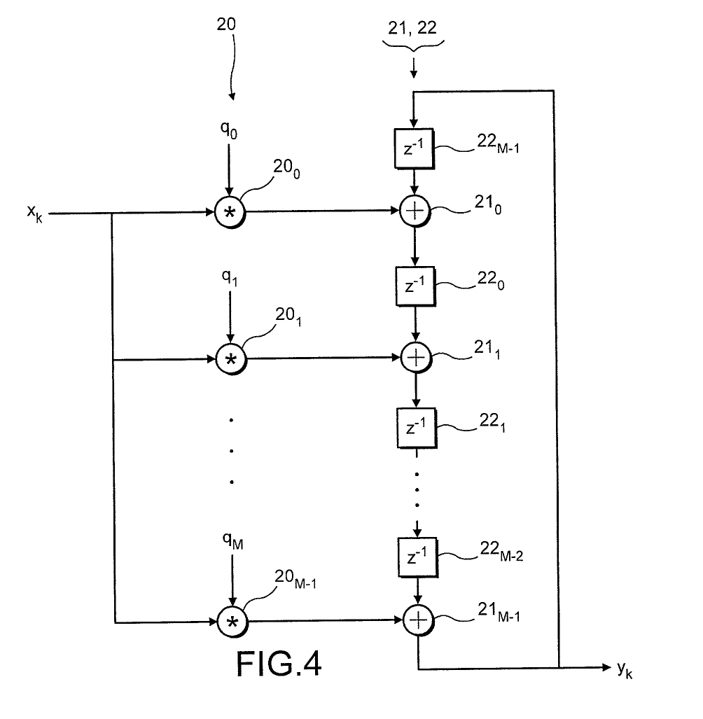

A first filter embodying the invention is depicted in FIG. 4. The filter comprises M parallel multipliers 20 (0 to M−1), M summing means 21 and M registers 22. The M registers 22 coupled with the summing means 21 is referred to as a Rotating Circular Accumulator (RCA).

The multipliers 20 are connected to receive the input signal xₖ, and respective coefficient values q₀ . . . qₘ₋₁. The outputs of the multipliers 20 are supplied to respective summing means 21. The summing means 21 are arranged in series such that each summing means 21 (except the first) receives an output of a corresponding multiplier 20 and the output of the previous summing means 21. The first summing means receives the output of the first multiplier and of the last summing means. The outputs from the summing means 21 are delayed by respective registers 22 before being supplied to the next summing means 21. Each summing means 21 produces an output equivalent to the sum of the two inputs thereto. Alternatively, negative value coefficients could be used in combination with “negative” summing means in which the multiplier input value is subtracted from the previous summing means input.

Just before time instant zero (k=0), the registers and coefficients, qₖ, are all initialized (preferably to zero, but see below). Then, at time instant k=0, one coefficient, q₀, is supplied to the first multiplier according to a scheme described below. Then, M multiplies are performed in parallel (i.e. all the multipliers) and the output of these multipliers are fed to the summing means and registers (RCA). The registers in the RCA are clocked. In doing this, the k=0 results from the multipliers are available to the summing means. At k=1, the next new coefficient (q₁) is loaded, multiplication is performed and the RCA is clocked. At each time instance, k, one coefficient is loaded into the RCA. The coefficient is given by:

$${q}_{mod ( k , M )} = {c}_{k}^{*} for all k = 0 … L - 1 , \qquad ( 12 )$$

where cₖ is a known sample of the pilot sequence. It can be seen that for each value of k, a coefficient cₖ^{*} is loaded in to the RCA at the position given by mod(k,M), i.e. at k=0, q₀ is set to c₀^{*} and at k=1, q₁ is set to c₁^{*} and so on until k=M−1. Then at k=M, q₀ is set to c_{M}^{*} and at k=M+1, q₁ is set to c^{*} _{M+1}. This continues until k=L−1. The final result is then available in the registers q₀ . . . qₘ₋₁ and the output is accessible by, for example, setting qᵢ=0 for all i and shifting out M samples after the last register in the RCA, see FIG. 4.

It could be beneficial to initiate the coefficients according to

$${q}_{i} = {c}_{i}^{*} for i = 0 … M - 1. \qquad ( 13 )$$

before the observation interval starts. Then at k=0,

$${q}_{mod ( k , M )} = {c}_{{k}_{+ M}}^{*} for all k = 0 … L - 1 - M , \qquad ( 14 )$$

The matched filter output yₖ is then obtained by, for instance, setting qᵢ=0 for all i (or the input x=0) and clocking out the results from the RCA.

It is important to avoid wrap-around in the summation points and, at the same time, to have an efficient implementation. Implementing a word-length for the worst case should, if possible, be avoided to save power and silicon area. This can be solved by using standard methods for add and saturate in each summation point. In a searcher, however, this is not the preferred method because it may deteriorate the possibility to find local maxima of the matched filter output.

One important observation is that it is when the received signal quality is good that the output of the correlation will take on extreme values (large values). Thus in these cases it may be sufficient to use a shorter pilot sequence over which correlation takes place.

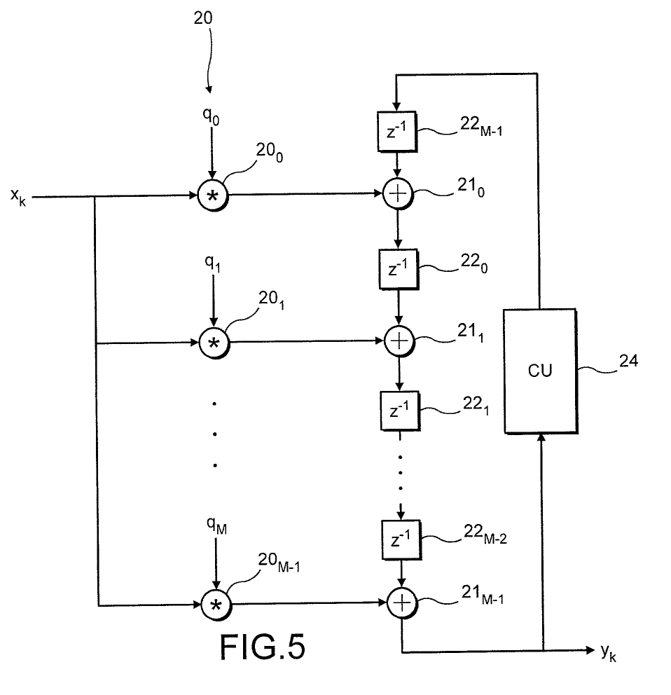

In an alternative embodiment of the invention, a Control Unit (CU) is provided in the RCA loop between the last and first summing means of the series, see FIG. 5. The CU operates to ensure that no wrap-around can occur. For instance if the absolute value of the input to the CU is larger then a certain pre-determined amount, then the CU abort the operation and thereby save time and avoid wrap-around. Alternative, when the RCA is used for other purposes than in a searcher, the CU could perform saturation and/or scaling of its output to avoid wrap around.

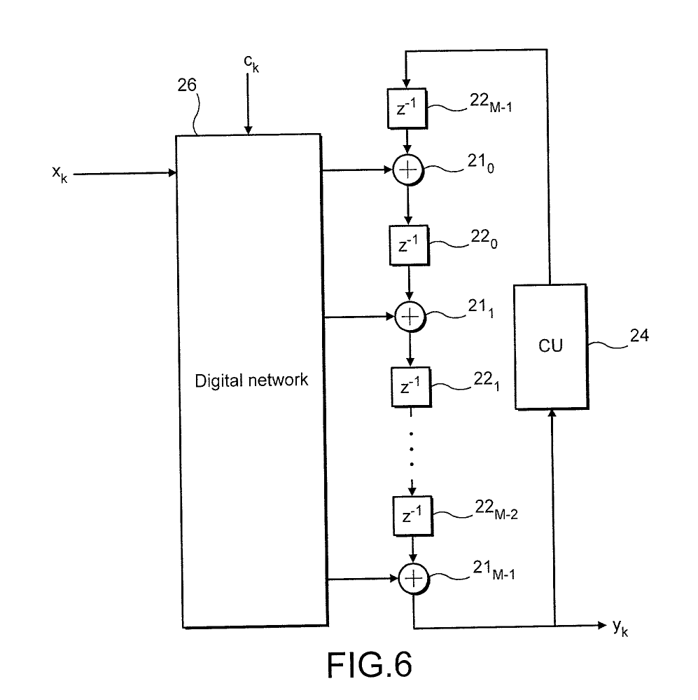

Each symbol of the code, cₖ, belongs to a finite alphabet. Thus if the size of this alphabet is less than M (which is a reasonable assumption in most cases) it may be feasible to implement the multiplier in a much more efficient way. Since all multipliers applies different code values to the same input signal and there is a limited set of code values, there is also a limited set of output values. For instance if the code can take on four different values (QPSK), then can be only four different outputs. Thus we only need four multiplies. The problem now is how to distribute these four output values to the RCA. This can be solved as shown in FIG. 6. A digital network 26 is provided instead of the multipliers to perform both multiplication and demuxing.

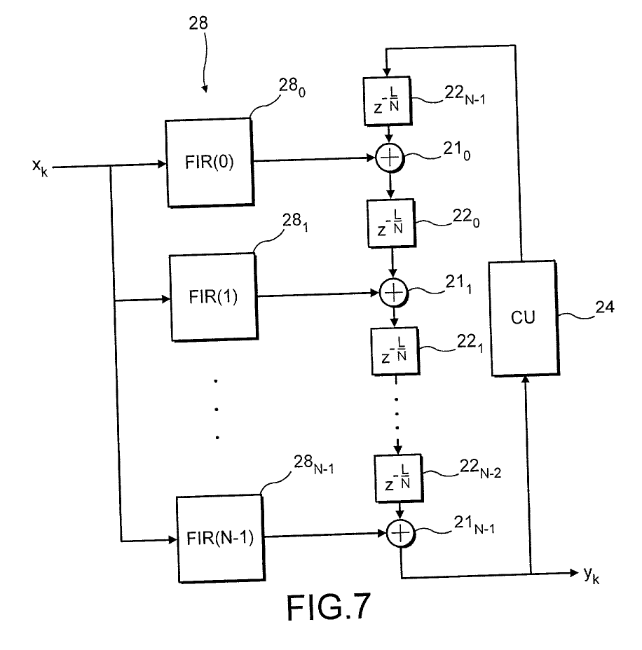

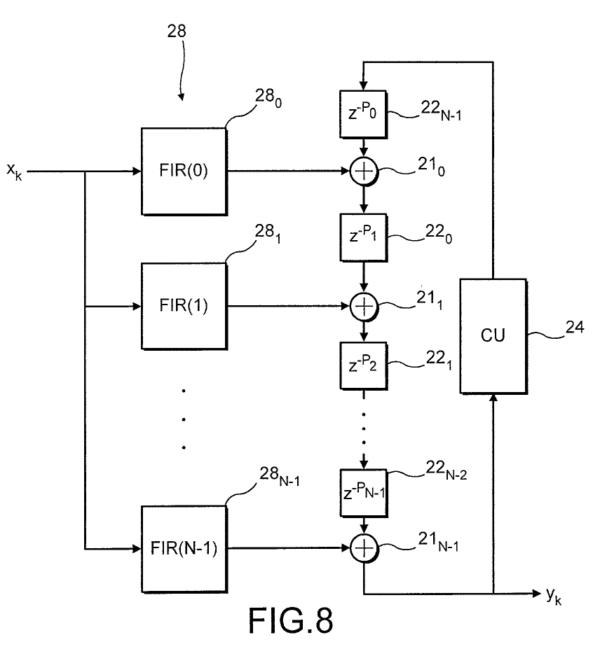

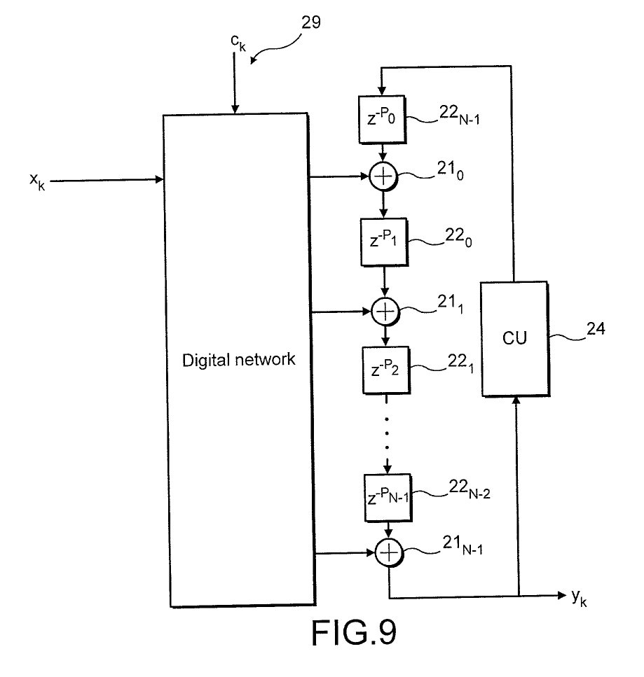

In a more generalized version of the RCA, each delay element could delay the signal more than one sample and the multipliers could be generalized to FIR filters 28, or even IIR filters, see FIGS. 7-9. In FIG. 7 all the FIR filters 28 have the same length L/N, that equals the length of the delays in the RCA. In FIG. 8, the delays in the RCA are independent of the filters. Finally, in FIG. 9 the filtering are done by means of a digital network.

1. A signal filter comprising:
a plurality of adding elements, each adding element has first and second inputs and an output and being operable to provide an output signal representative of the sum of a pair of input signals; and
a plurality of delay line elements, each delay line element having an input and an output and being operable to delay transfer of an input signal from the input to the output by a predetermined time period,
wherein the adding elements and delay line elements are connected in a series such that the output of each adding elements, except the last adding element in the series, is connected to the first input of the next adding element in the series via an associated delay line element, the output of the last adding element in the series being connected to the first input of the first adding element in the series via a delay line element,
and wherein the second input of the adding elements are connected to receive respective input signals.

2. A signal filter as claimed in claim 1, comprising multiplier means having an input and a plurality of outputs, the multiplier means being operable to receive an input signal and a plurality of coefficient signals, and to produce a plurality of output signals representative of the input signal multiplied by respective coefficient signals, the outputs of the multiplier being connected to the second inputs of respective adding elements.

3. A signal filter as claimed in claim 1, wherein the multiplier means are provided by finite impulse response filters.

4. A signal filter as claimed in claim 1, wherein the multiplier means are provided by infinite impulse response filters.

5. A filter for providing a filtered output signal from a received input signal, the filter comprising
an input for receiving an input signal;
an output for transmitting an output signal;
a first plurality of multipliers, each connected to receive the input signal from the input and a respective coefficient, and operable to produce respective output signals in dependence upon the input signal and the coefficient;
a second plurality of adding means connected to receive respective multiplier output signals as a first input thereto, the second plurality equalling the first plurality, the adder means being arranged in a series such that each adding means of the series, except the first in the series, receives the output of the previous adding means of the series as a second input thereto, the first adding means of the series receiving the output of the last adding means of the series as a second input thereto,
wherein each adding means receives its second input via a delay line element, and the output of the last adding means in the series provides the output of the filter.

6. A pilot signal searcher for use in a CDMA telecommunications system, the searcher including a filter as claimed in any one of the preceding claims.

7. A pilot signal searcher for a time synchronised receiver in a telecommunications system, the searcher including a filter as claimed in any one of claims 1 to 5.
